(19) United States
(12) Patent Application Publication
(10) Pub. No.: US 2006/0163178 A1
(43) Pub. Date: Jul. 27, 2006

(54) System and method for providing high vacuum remediation

(75) Inventors: Ronny C. Crawford, Rhome, TX (US); J. Michael Hawthorne, Keller, TX (US); Gregory A. Ponder, Lewisville, TX (US)

Correspondence Address: RUBEN C. DELEON;WINSTEAD SECHROST & MINICK P.C., P.O. BOX 50784, DALLAS, TX, 75201, US

(73) Assignee: H2A Environment, Ltd., Southlake, TX (US)

(21) Appl. No.: 10/758,657

(22) Filed: Jan. 15, 2004

Related U.S. Application Data
(60) Provisional application No. 60/440,311, filed on Jan. 15, 2003.

(51) Int. Cl. C02F 1/00

(52) U.S. Cl. 210/808; 210/121; 210/257.1; 210/406; 210/767

(57) ABSTRACT

The present disclosure provides a system and method for providing high vacuum remediation.

### BACKGROUND OF THE INVENTION

The present disclosure relates generally to a system and method of providing high vacuum remediation of contaminants within a site.

Improper handling and storage of petroleum and other hazardous chemicals can result in leaks and spills and pose a serious threat to the quality of the environment. Petroleum, additives and a variety of industrial chemicals have been discovered in many groundwater supplies. In some wells, only trace quantities have been discovered; in others, levels have exceeded Federal and State drinking water standards. Hundreds of drinking water supplies have been closed because of excessive chemical contamination.

Water contamination is only one consequence of poor handling practices. Mismanagement of some substances may pose occupational hazards, present a fire or explosion risk, or result in a release of odors or fumes with serious public health and environmental consequences to the neighboring community.

Gasoline, which fuels the millions of automobiles we all drive each day, is highly flammable and can flash violently when ignited. Gasoline and many other hazardous chemicals when inhaled can cause drowsiness, nausea, and other adverse health effects.

Once a chemical soaks into the ground, it disperses and may dissolve and contaminate a water supply for many years. Cleanup is often difficult and it is usually expensive.

Therefore, what is needed, is a system and method to effectively remove such hazardous liquids from any groundwater supplies.

### SUMMARY OF THE INVENTION

The present disclosure provides a system and method of providing remediation of contaminants within a site.

Therefore, in accordance with the previous summary, objects, features and advantages of the present disclosure will become apparent to one skilled in the art from the subsequent description mid the appended claims taken in conjunction with the accompanying drawings.

### BRIEF DESCRIPTION OF THE DRAWINGS

FIG. 1 is a process flow diagram of the preferred embodiment;

FIG. 2 is a side view of the preferred embodiment;

FIG. 3 is another side view of the preferred embodiment;

FIG. 4 is a top view of the preferred embodiment;

FIG. 5 is a front and back view of the preferred embodiment along with the trailer;

FIG. 6 is a front and back view of the preferred embodiment without the railer;

FIG. 7 is three views of the knock-out tank of the preferred embodiment; and

FIG. 8 is three views of the product tank of the preferred embodiment.

### DETAILED DESCRIPTION OF THE PREFERRED EMBODIMENTS

The present disclosure can be described by the embodiments given below. It is understood, however, that the embodiments below are not necessarily limitations to the present disclosure, but are used to describe a typical implementation of the invention.

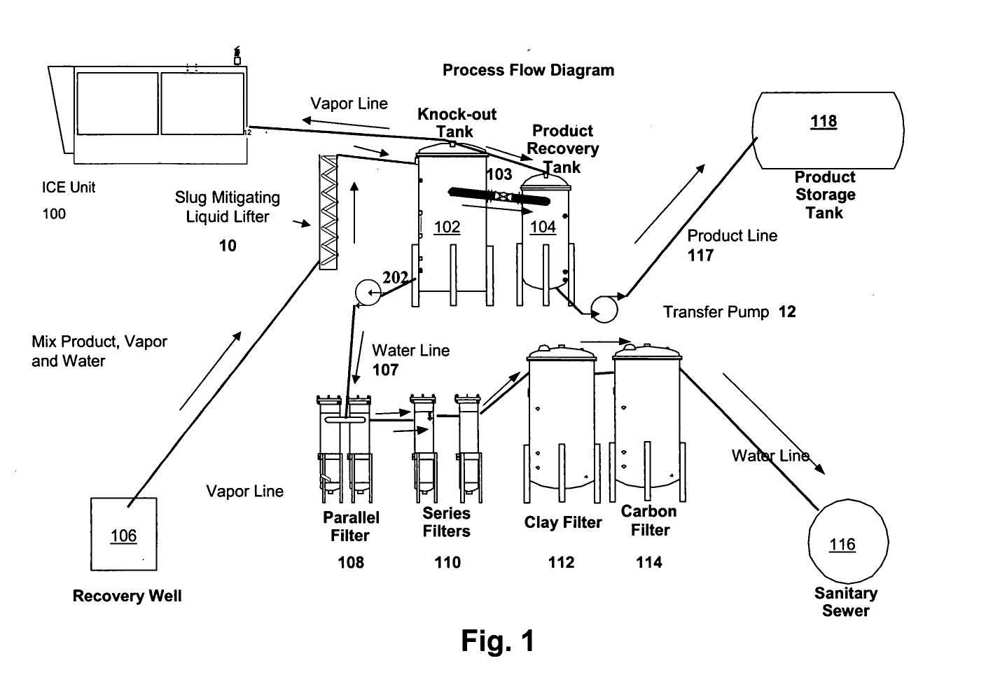

FIG. 1 illustrates a process flow of the preferred embodiment. In this embodiment, a site has diesel fuel that leaked underground from a diesel fuel storage tank. In addition, this embodiment is typically used for other Light Non-Aqueous Phase Liquid (LNAPL) remediation. An Internal Combustion Engine (ICE) unit 100 is used to produce a vapor line to a knock-out tank 102 and a recovery tank 104.

Both the knock-out tank 102 and the recovery tank 104 are kept under vacuum pressure. In addition, the vapor line extends from the knock-out tank 102 to a recovery well 106 and draws out a mixture of product, vapor and water. Note that more than one vapor line can extend to many recovery wells at the same time although only one is shown in this embodiment. Note also that a slug mitigating liquid lifter 10 is used to transfer the mixture to the knock-out tank 102. The slug mitigating liquid lifter 10 uses a coiled long hose to help decrease the amount of slope of the rise. The decreased slope in turn helps keep the water and product separated. In contrast, a large rise would increase the amount of back and forth movement of the mixture and thus cause more of the mixture to combine.

Once the mixture of product, vapor and water is drawn up to the knock-out tank 102, the product and water stay separated because of the immiscibility of the water and product. Product and water separation is dependent upon retention time and gravity. A baffle between the entry point and product exit points of the knock-out tank 102 increases the retention time of the fluids in the knock-out tank 102. Adjustable float switches control the level of the product and water interface in the knock-out tank 102 such that the product is allowed to accumulate in the knock-out tank 102 until such time as a sufficient volume has accumulated to reach the recovery line 103 to the recovery tank 104. Since the product stays on top of the water in this embodiment and both tanks 102 and 104 are under pressure vacuum, the product recovery line 103 carries product from the knock-out tank 102 to the product recovery tank 104. The product then is transferred to a product storage tank 118 through a product line via a transfer pump 12 that is controlled by a series of level switches on the recovery tank 104. Because the switches that control the level of the product and water interface in the knock-out tank 102 are adjustable, the knock-out tank 102 and recovery tank 104 can be configured to separate product and water as described above or they can be set to manage all produced fluids as total fluids without separating the product and water.

Moreover, since the water stays on the bottom of the knock-out tank 102, a valve at the bottom of the tank 102 allows the water to be pumped via a transfer pump 202 to a set of parallel filters 108. The water then travels to a series of filters 110 and then into a clay filter 112 and a carbon filter 114. Once the water completes this filtration process, the water is transferred to a sanitary sewer or other disposal option 116. Although a particular example of filter sets is shown, the set of filters can include any combination of or none of the parallel, series, clay and carbon filters and still remain within the scope of the invention.

Additionally, some of the gas product is recovered by the ICE 100 and used as fuel for the engine. The ICE 100 in turn bums off exhaust similar to most internal combustion engines.

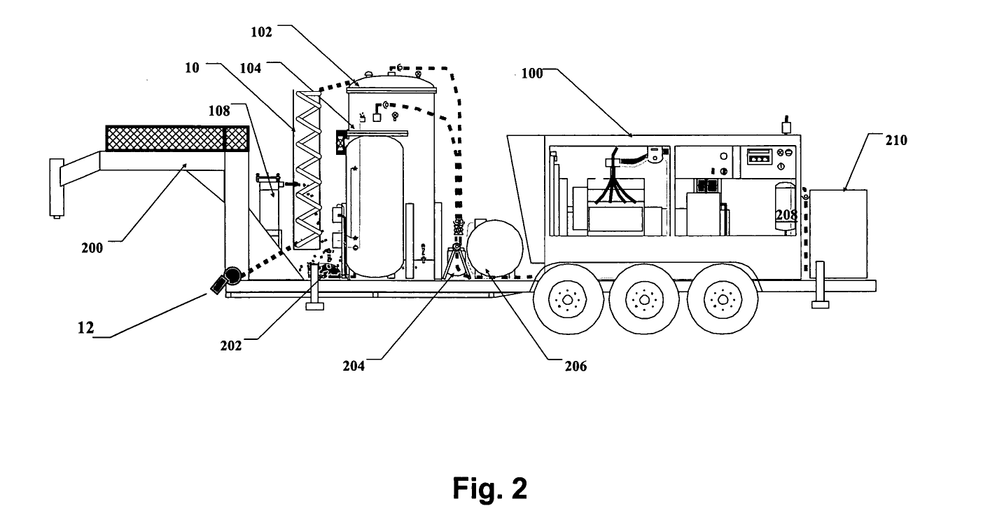

Now turning to FIG. 2, a trailer 200 is shown to house the preferred embodiment. Knock-out tank 102, slug mitigating liquid lifter 10, and product tank 104 are shown side by side along with ICE 100 as shown in FIG. 1. A filter 108 is shown which could be a set of parallel filters and/or a set of series filters. The filter 108 is connected to the tanks 102 and 104 by a set of pumps 202. In addition, a particulate filter 204 is shown that removes water from a vapor hose that originates at the ICE 100 and ends up at the top of knockout tank 102 and product tank 104. A liquid propane tank 206 is also shown that is used to fuel the ICE 100. Initially, the ICE 100 will most likely use the propane tank 206 as fuel, and then use a combination of some of the gas product recovered and the propane as fuel as the process continues. Moreover, another filter 208 is enclosed within the ICE 100 that also helps remove water from the vapor line. Further, this embodiment shows a toolbox 210.

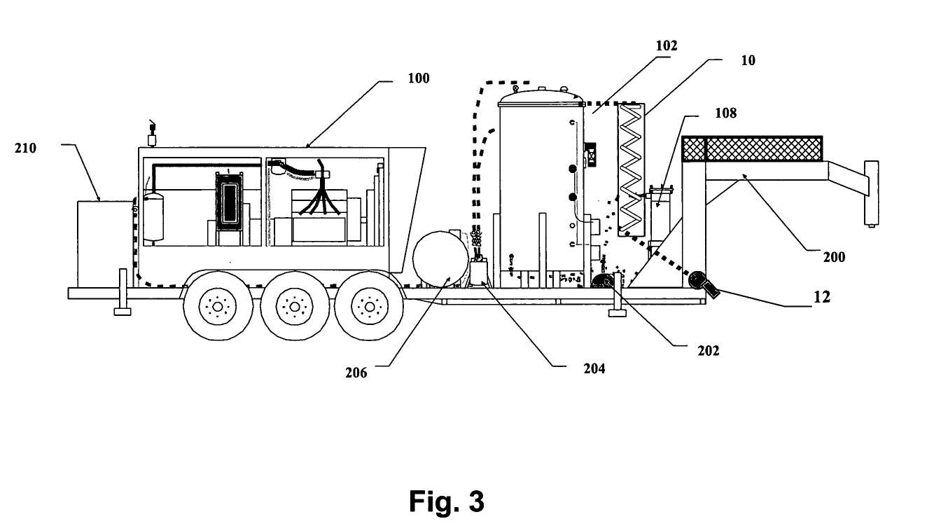

FIG. 3 also shows the trailer 200, the knock-out tank 102, the manifold 203, the slug mitigating liquid lifter 10, the ICE 100, the filter 108, the set of pumps 202, the particulate filter 204, the liquid propane tank 206, and the toolbox 210.

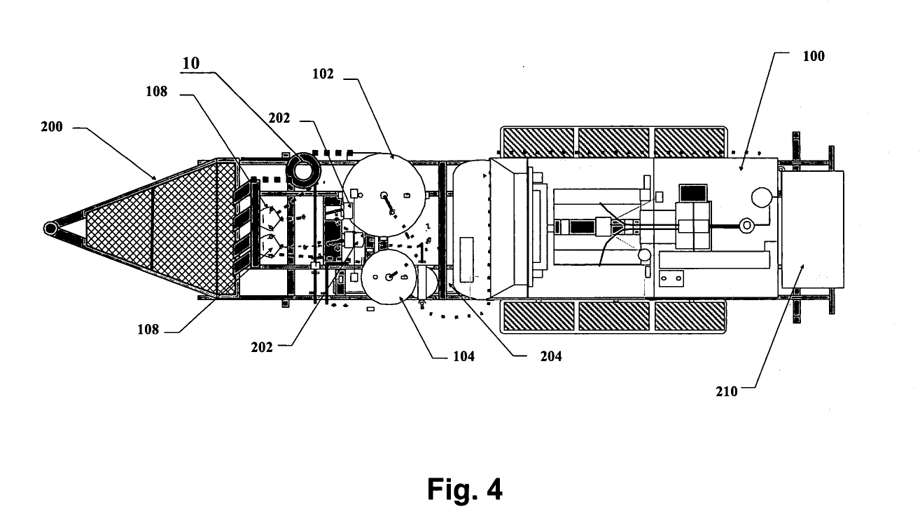

FIG. 4 shows the top view of the preferred embodiment. As in the other figures, the trailer 200 is shown to house the slug mitigating liquid lifter 10, the knock-out tank 102 and the product tank 104. In addition, the filters 108 are shown as they are connected through a hose to the set of pumps 202 to the knockout tank 102 and the product tank 104. In addition, the particulate filter 204 is shown along with the vapor hose that originates at the ICE 100 and ends up at the knock-out tank 102 and the product tank 104. Additionally, the toolbox 210 is also shown in this figure.

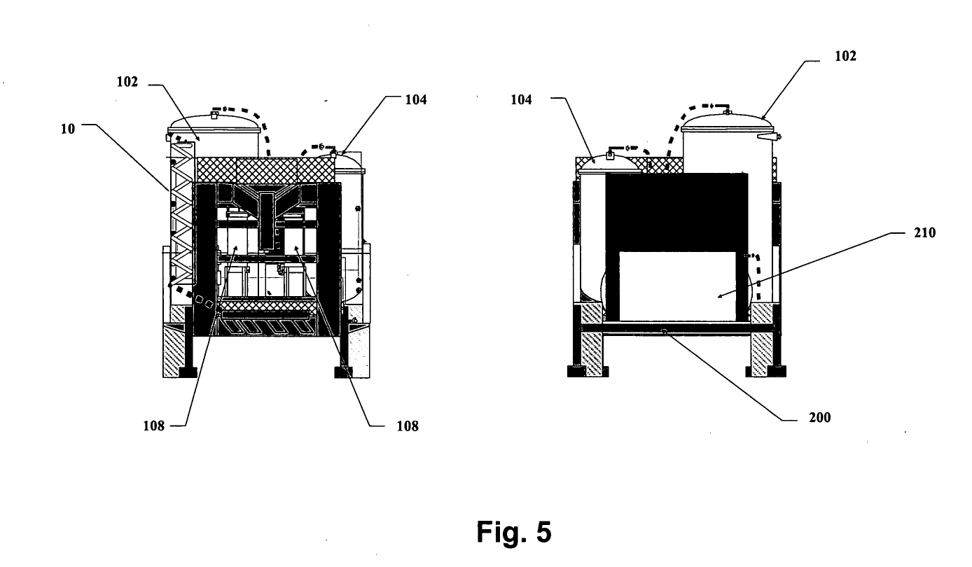

FIG. 5 shows the front and back view of the embodiment along with the trailer 200. The knock-out tank 102, the slug mitigating liquid lifter 10 and the product tank 104 are shown positioned on the trailer 200 on the front and back view, along with the toolbox 210 on the back view. Moreover, the set of filters 108 is also shown on the front view.

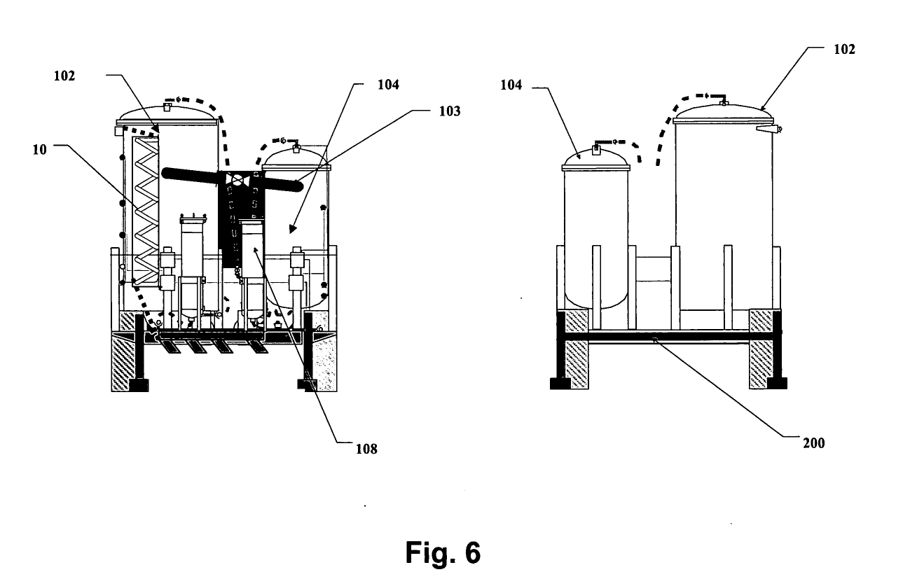

FIG. 6 shows the front and back view of the embodiment without the trailer to show more detail of the tanks 102 and 104. In particular, slug mitigating liquid lifter 10 is shown that brings in the mixture of product and water from the recovery wells. The intake hose also attaches to the slug mitigating liquid lifter 10 attaches to the knock-out tank 102 near the top of the tank 102. Further, a connection 103 is shown between the knock-out tank 102 and the product tank 104 to allow product to flow from the knock-out tank 102 since the water settles near the bottom of the knock-out tank 102 and the product separates near the top of the tank 102, as controlled by the interior baffle in the knock-out tank 102 and the adjustable float switches at various locations along the side of knock-out tank 102 that control the level of the product and water interface such that product accumulates near the top of the knock-out tank 102. The connection 103 is positioned on the knock-out tank 102 to allow only product to flow into the product tank 104 when the system is operated in product and water separation mode. Moreover, the levels of product and water are maintained in order to allow only product to flow to the product tank 104 when operating in product and water separation mode. Alternatively, the adjustable float switches on knock-out tank 102 that control the product and water interface level in knock-out tank 102 can be adjusted such that either total fluids are contained in and subsequently pumped from knock-out tank 102 and recovery tank 104 is not used, or the switches can be adjusted such that total fluids are transferred from knock-out tank 102 to recovery tank 104 and then pumped from recovery tank 104.

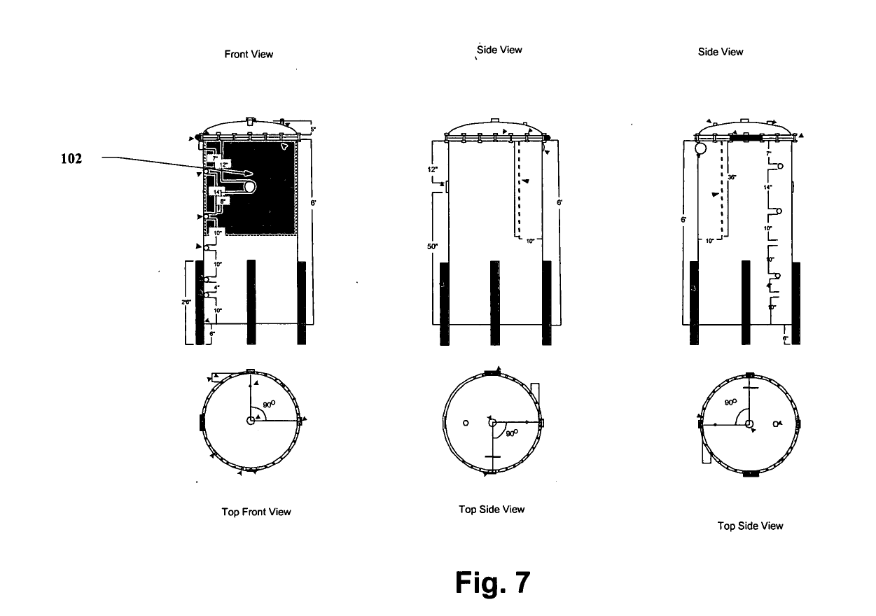

FIG. 7 shows three more views of the knock-out tank 102 to show more detail of how a knock-out tank can be configured.

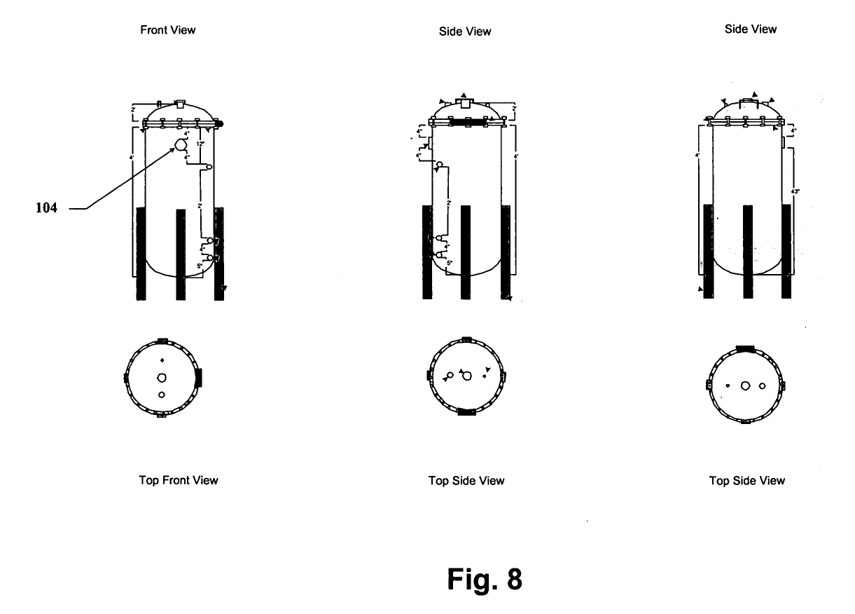

FIG. 8 shows three more views of the product tank 104 to show more detail of how a product tank can be configured.

It is understood that several modifications, changes and substitutions are intended in the foregoing disclosure and in some instances some features of the invention will be employed without a corresponding use of other features. For example, instead of disbursing the water to a sanitary sewer, the water could be disbursed to a storm sewer, discharged as surface water, captured in a tank for later treatment, re-injected into the sub-surface, as well as other methods of removal. In addition, the invention can also use other types of vacuum pumps other than the ICE. For example, a liquid ring pump, or other types of vacuum pumps can be used. Other modifications, changes and substitutAccordingly, it is appropriate that the appended claims be construed broadly and in a manner consistent with the scope of the invention.

What is claimed is:

1. A system for separating product from a mixture of product and water in a remediation system, the system comprising:
a first set of hoses;
a vacuum supply introducing vacuum pressure into the first set of hoses;
a first tank for holding a mixture of fluids and connected to the first set of hoses;
a first pump connected to a bottom portion of the first tank;
a first set of adjustable float switches within the first tank, wherein the first set of adjustable float switches control the first pump;
a second tank for holding product from the first tank and connected to the first tank; and
at least one recovery well connected to the first tank by a second set of hoses.

2. The system of claim 1, further including a product storage tank connected to the second tank, wherein the product storage tank stores product.

3. The system of claim 1, further including a coiled long hose connected to the first tank for lifting the product mixture to the first tank.

4. The system of claim 1, further including at least one filter between the first tank and a sanitary sewer.

5. The system of claim 1, wherein the vacuum supply includes an internal combustion engine.

6. The system of claim 1, wherein the first tank is connected to the second tank by a connection that is higher in the first tank than in the second tank.

7. A method for separating product from a mixture of product and water in a remediation system, the method comprising:
applying vacuum pressure into a first set of hoses;
holding a mixture of fluids in a first tank, wherein the first tank is connected to the first set of hoses;
controlling a pump at a bottom portion of the first tank by a set of adjustable float switches in the first tank;
holding product from the first tank in a second tank connected to the first tank; and
recovering product and water from at least one recovery well connected to the first tank by a second set of hoses.

8. The method of claim 7, further including connecting a product storage tank to the second tank, wherein the product storage tank stores product.

9. The method of claim 7, further including connecting a long coiled hose to the first tank and for lifting the mixture of fluids to the first tank.

10. The method of claim 7, further including connecting at least one filter between the first tank and a sanitary sewer.

11. The method of claim 7, wherein the applying the vacuum pressure is provided by an internal combustion engine.

12. The method of claim 7, wherein the first tank is connected to the second tank by a connection that is higher in the first tank than in the second tank.

13. A system for separating product from a mixture of product and water in a remediation system, the system comprising:
a first set of hoses;
an vacuum supply introducing vacuum pressure into the first set of hoses;
a first tank for holding a mixture of fluids and connected to the first set of hoses;
a first pump connected to a bottom portion of the first tank;
a first set of adjustable float switches within the first tank, wherein the first set of adjustable float switches control the first pump;
a second tank for holding product from the first tank and connected to the first tank;
at least one recovery well connected to the first tank by a second set of hoses; and
a third set of hoses connected to the first tank to dispose of water from the first tank.

14. The system of claim 13, further including a product storage tank connected to the second tank, wherein the product storage tank stores product.

15. The system of claim 13, further including a sanitary sewer connected to the first tank through the third set of hoses and at least one filter between the first tank and sanitary sewer.

16. The system of claim 13, wherein the vacuum supply includes an internal combustion engine.

17. The system of claim 13, wherein the first tank is connected to the second tank by a connection that is higher in the first tank than in the second tank.

18. The system of claim 15, wherein the at least one filter includes a clay filter.

19. The system of claim 13, further including a coiled long hose connected to the first tank for lifting the product mixture to the first tank.

20. The system of claim 13, wherein the vacuum supply uses at least a portion of the product and water as fuel.
